(19) United States
(12) Patent Application Publication
(10) Pub. No.: US 2020/0279235 A1
(43) Pub. Date: Sep. 3, 2020

(54) PAYMENT TRANSFER PROCESSING SYSTEM

(71) Applicant: AMERICAN EXPRESS TRAVEL RELATED SERVICES COMPANY, INC., New York, NY (US)

(72) Inventors: Laurence Booth, Horsham (GB); Jaromir Divilek, New York, NY (US); Alan Holmes, Hove (GB); Yasmin Ibrahim, New York, NY (US); Venkata Balaji Kollu, Phoenix, AZ (US); Lisa Raylesberg, New York, NY (US); Subrahmanyam Vishnuvajh, Phoenix, AZ (US)

(73) Assignee: AMERICAN EXPRESS TRAVEL RELATED SERVICES COMPANY, INC., New York, NY (US)

(21) Appl. No.: 16/290,284

(22) Filed: Mar. 1, 2019

(51) Int. Cl. G06Q 20/10; G06Q 20/40; G06Q 40/02

(52) U.S. Cl. CPC G06Q 20/102; G06Q 20/405; G06Q 40/025; G06Q 20/409

(57) ABSTRACT

Systems and methods for processing payment transfers are disclosed. The system may allow senders to remit payments to receivers. The system may receive a payment request. The system may execute a payment risk analysis on the payment request to determine a risk assessment. Based on the risk assessment, the system may invoke a payment processor to complete the payment request. The payment processor may transmit a debit pull to a sender bank. In response to receiving the debit pull the sender bank may debit the payment amount from a sender account from the sender data. The payment processor may transmit a credit push to a receiver bank. In response to receiving the credit push the receiver bank may credit the payment amount to a receiver account from the receiver data.

### FIELD

The disclosure generally relates to financial transactions, and more specifically, to a payment transfer processing system to complete payments for transactions.

### BACKGROUND

Users (e.g., senders) may desire to electronically transfer money to a second user (e.g., receivers). Users may use a money transfer product, an automated clearing house (ACH) payment process, or a similar money transfer process to electronically transfer money. Typical money transfer products are limited to transfers between users using the same transfer platform, or within the same network, to send and/or receive the money. For example, the sender and the receiver may register and use a common platform to complete money transfers (e.g., a money transfer platform offered by PAYPAL® or VENMO®) or may transfer funds within a fixed network of banks (e.g., a transfer service offered by ZELLE®). Typical ACH payment processes require the user to input or provide bank routing and account numbers to the receiver (e.g., a merchant) to complete the electronic money transfer.

Typical money transfer processes do not provide a risk assessment or fraud assessment on money transfers; thus, money may be lost in response to the sender transferring money to the wrong receiver. Further, money transferred between the parties may not be available to the receiver in real time, as a delay is typically needed to ensure that funds are available and to ensure the money is properly transferred between the parties.

### SUMMARY

Systems, methods, and articles of manufacture (collectively, the “system”) for processing payment transfers are disclosed. The system may execute a payment risk analysis on a payment request, wherein the payment request comprises sender data, receiver data, and a payment amount, and wherein the payment risk analysis determines a risk assessment associated with the payment request. The system may generate a payment processing request in response to the risk assessment comprising a low risk. The system may transmit a debit pull to a sender bank from the sender data, wherein in response to receiving the debit pull the sender bank debits the payment amount from a sender account from the sender data. The system may transmit a credit push to a receiver bank from the receiver data, wherein in response to receiving the credit push the receiver bank credits the payment amount to a receiver account from the receiver data.

In various embodiments, the debit pull and the credit push may be transmitted simultaneously, near simultaneously, or at a time proximate each other. The system may transmit an authentication challenge in response to the risk assessment comprising a medium risk. The system may receive an authentication challenge response based on the authentication challenge. The system may validate the authentication challenge response by comparing the authentication challenge to the authentication challenge response. The system may decline the payment request in response to the risk assessment comprising a high risk.

In various embodiments, the operation of executing the payment risk analysis may comprise validating sender bank data from the sender data, wherein the sender bank data is validated by verifying sender bank login information from the sender bank data and validating that the sender account comprises sufficient funds to complete the payment request based on the payment amount. The operation of executing the payment risk analysis may also comprise capturing a user device characteristic from a user device, and determining the risk assessment by comparing the user device characteristic to historical transaction fraud data.

In various embodiments, the system may assign a unique identifier to the payment request. The unique identifier may comprise a legacy identifier compatible with a legacy payment system, and wherein the legacy identifier comprises a checking account number, a savings account number, a credit card number, a commercial account number, a commercial charge card number, or a direct deposit account number. The system may approve the payment request in response to transmitting the debit pull and the credit push. In an exemplary practical application, the payment request may be initiated between a customer and a merchant as payment for a transaction, and in response to the payment request being approved, the merchant may complete the transaction with the customer.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for processing payment transfers, in accordance with various embodiments;

FIG. 2 is a block diagram illustrating various system components of an exemplary risk and fraud assessment platform for a system for processing payment transfers, in accordance with various embodiments;

FIG. 3 is a block diagram illustrating various system components of an exemplary payment processor for a system for processing payment transfers, in accordance with various embodiments;

FIG. 4 illustrates a process flow for a method of processing payment transfers, in accordance with various embodiments; and

FIG. 5 illustrates a process flow for a method of analyzing risk in a payment transfer, in accordance with various embodiments.

### DETAILED DESCRIPTION

In various embodiments, systems and methods for processing payment transfers are disclosed. The system enables a first user (e.g., a sender) to transfer money to a second user (e.g., a receiver). For example, in an exemplary practical application, the sender may comprise a customer and the receiver may comprise a merchant. The customer may initiate and complete a money transfer (e.g., the payment transfer) to the merchant to complete a transaction with the merchant (e.g., to purchase goods, services, etc.). In that regard, the system provides a technical solution to the technical problem presented in typical money transfer platforms and processes, by enabling the transfer of money to be completed regardless of the platform, transaction account, and/or bank used by the sender and/or receiver. For example, the sender and the receiver may each use different types of transaction accounts (e.g., checking, savings, credit, etc.) and through different banks and/or issuers. The receiver may receive the payment transfer using a digital form (e.g., a digital token, a digital wallet, etc.), or via a physical transaction instrument.

The system may include another practical application of providing a fraud and/or credit risk assessment of the payment transfer. The assessment may ensure that the sender and/or the receiver is not fraudulently using the system. The assessment may ensure that the sender has the necessary funds to complete the payment transfer with the receiver. The assessment may also ensure that the sender is transferring the funds to the correct receiver. In various embodiments, by assessing the fraud risk and/or credit risk before completing the payment transfer, the system may also ensure that the payment transfer is completed in real time, or near real time, such that the funds are available to the receiver in response to the system completing the payment transfer.

In various embodiments, the system further improves the functioning of the computer and the payment network. For example, by transmitting, storing, and accessing data using the processes described herein, the security of the data is improved, which decreases the risk of the computer or network from being compromised. As an example, by providing additional steps of authenticating the sender before transmitting the payment, the security of the payment transfer is improved, decreasing the risk of money being transferred to an incorrect party, or of a third party fraudulently initiating or intercepting the money transfer.

In various embodiments, by processing the payment transfer using the process described herein, the system may transmit less sensitive information between the parties in the transaction. For example, instead of typical ACH processes wherein the user provides checking account numbers and routing numbers to the merchant, the merchant may only receive a transaction identifier and metadata associated with the transaction. Therefore, the security of the sensitive information is increased compared to typical money transfer systems. Moreover, needed payment information in the system may only be processed and stored by the payment system. In that regard, the storage needs are reduced for the merchant system, and the merchant system may increase computing efficiencies (e.g., CPU, memory, etc.) as a result of processing less data.

In various embodiments, a merchant may register with the system to enable payment transfers as an option for a customer to select to complete a transaction. In various embodiments, the registration process may be non-invasive for the merchant system, thus reducing the processing needs and duration of time needed for the merchant to enable payment transfers using the processes described herein. For example, the merchant system may simply add a button, image, link, or the like, to the merchant's website, and may be compatible with suitable programming languages. In response to the customer selecting (e.g., clicking on) the button, image, link, or the like during a checkout process, the system may initiate the payment transfer using the processes described herein.

Further, and in accordance with various embodiments, by processing the payment transfer using the process described herein, the user may perform less computer functions and provide less manual input. In that respect, the user device accessed by the user may save on data storage and memory, which speeds processing compared to typical money transfer systems. By providing less manual input, the user may also save on battery usage in user devices operated by a battery source.

In various embodiments, by providing direct integration to existing payment networks, the system eliminates the need to add additional infrastructure (e.g., computing resources (CPU/Memory), storage, interfaces, etc.) on a payment platform.

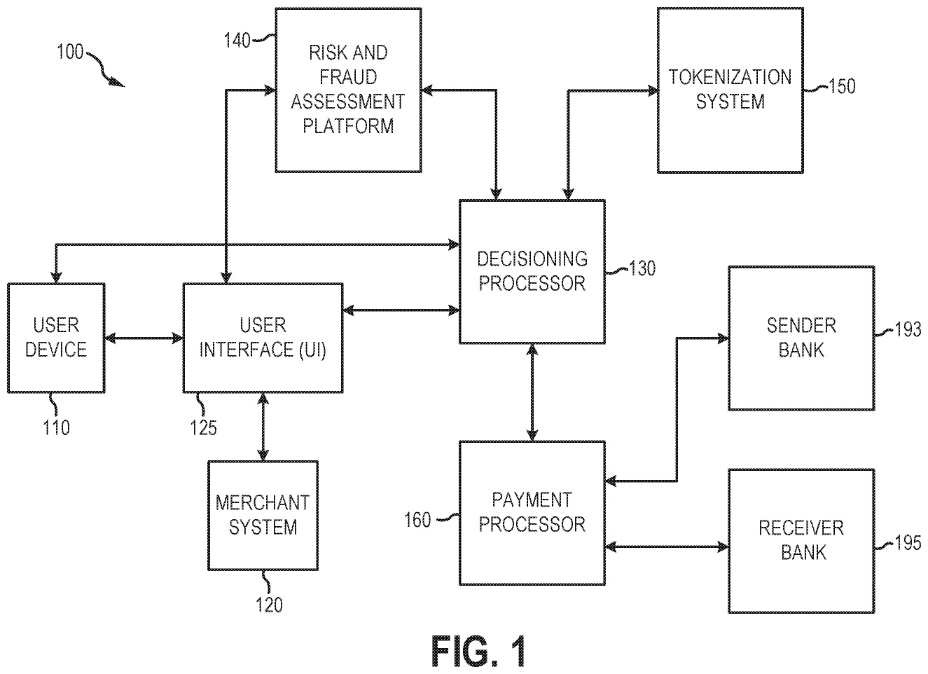

In various embodiments, and with reference to FIG. 1, a system 100 for processing payment transfers is disclosed. System 100 may comprise one or more of a user device 110, a merchant system 120, a decisioning processor 130, a risk and fraud assessment platform 140, a tokenization system 150, a payment processor 160, a sender bank 193, and/or a receiver bank 195. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, a user (e.g., the sender) may access and interact with user device 110 to initiate a transaction and initiate and complete a payment transfer to complete the transaction. User device 110 may be in electronic communication with merchant system 120, via a user interface (UI) 125, and/or decisioning processor 130. User device 110 may comprise any suitable hardware, software, and/or database components capable of sending, receiving, and storing data. For example, user device 110 may comprise a personal computer, personal digital assistant, cellular phone, smartphone (e.g., IPHONE®, BLACKBERRY®, and/or the like), IoT device, and/or the like. User device 110 may comprise an operating system such as, for example, a WINDOWS® mobile operating system, an ANDROID® operating system, APPLE® IOS®, a BLACKBERRY® operating system, a LINUX® operating system, and the like. User device 110 may also comprise software components installed on user device 110 and configured to allow via user device 110 access to various systems, services, and components in system 100. For example, user device 110 may comprise a web browser (e.g., MICROSOFT INTERNET EXPLORER®, GOOGLE CHROME®, etc.), an application, a micro-app or mobile application, or the like configured to allow user device 110 to access UI 125.

In various embodiments, user device 110 may comprise various user device characteristics (e.g., user device data). The user device characteristics may correspond to software, hardware, and/or physical parameters and settings of user device 110. For example, user device 110 may comprise a unique device ID, an IP address, an operating system type (e.g., WINDOWS®, ANDROID®, APPLE® IOS®, LINUX®, etc.), a web browser type (e.g., MICROSOFT INTERNET EXPLORER®, GOOGLE CHROME®, etc.), an enabled language (e.g., English, Spanish, Italian, etc.), a screen resolution setting, scripting settings (e.g., JAVACRIPT® enabled web browser), an anonymous IP indicator, and/or the like. In various embodiments, one or more user device characteristics may be captured by risk and fraud assessment platform 140 in response to the initiation of a transaction and/or payment transfer, as discussed further herein.

In various embodiments, merchant system 120 may be configured to enable a merchant (e.g., the receiver) to receive transaction requests from a user, submit transaction authorization requests to a payment network and/or issuer system to authorize the transaction, and/or to interact with the user to sell or offer goods and/or services. Merchant system 120 may incorporate one or more hardware, software, and/or database components. For example, merchant system 120 may comprise one or more network environments, servers, computer-based systems, processors, databases, datacenters, and/or the like. In various embodiments, merchant system 120 may be computer based, and may comprise a processor, a tangible non-transitory computer-readable memory, and/or a network interface, along with other suitable system software and hardware components. Instructions stored on the tangible non-transitory memory may allow merchant system 120 to perform various operations, as described herein.

Merchant system 120 may include a graphical user interface (“GUI”), software modules, logic engines, various databases, and/or the like, configured to enable user access to merchant system 120. For example, merchant system 120 may comprise and/or be in electronic communication with UI 125. UI 125 may be configured to provide a web-based interface for a user to access, view goods and/or services available by the merchant, initiate and complete transactions with the merchant, and/or select to pay for the transaction using a payment transfer. UI 125 may also be configured to display one or more prompts to the user for completing the payment transfer, as discussed further herein.

In various embodiments, decisioning processor 130 may be configured to receive risk and fraud assessment data from risk and fraud assessment platform 140 and trigger the processing of the payment transfer based on the assessment, as discussed further herein. Decisioning processor 130 may be in electronic communication with user device 110, UI 125, tokenization system 150, risk and fraud assessment platform 140, and/or payment processor 160. Decisioning processor 130 may comprise may comprise one or more hardware, software, and/or database components. For example, decisioning processor 130 may comprise one or more network environments, servers, computer-based systems, processors, databases, and/or the like. Decisioning processor 130 may comprise at least one computing device in the form of a computer or processor, or a set of computers/processors, although other types of computing units or systems may be used such as, for example, a server, web server, pooled servers, or the like. Decisioning processor 130 may also include software, such as services, APIs, SDKs, and the like, configured to perform various operations discussed herein. In various embodiments, decisioning processor 130 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, decisioning processor 130 may also be configured to transmit an authentication challenge to user device 110 based on the risk and fraud assessment completed by risk and fraud assessment platform 140, as discussed further herein. The authentication challenge may be transmitted to user device 110 via any suitable transmission channel (e.g., SMS, MMS, email, push notification, phone call, etc.). The transmission channel may be selected by the user, or may be based on historic account or payment information associated with the user. The authentication challenge may comprise a multi-factor authentication challenge. For example, if the user had previously registered with system 100 using a biometric input, username and password, or the like, the authentication challenge may comprise data prompting the user to input the biometric input together with the user's password (e.g., a 2-factor authentication), via user device 110. Decisioning processor 130 may compare the received input against stored biometric data, username and password data, or the like to validate the user's response and authenticate the user. As a further example, two-factor authentication may comprise sending an authentication number (e.g., a PIN, a code, a 6-digit number, a one-time password, etc.) via the transmission channel, and prompting the user to input the authentication number into user device 110. Decisioning processor 130 may compare the input authentication number to the authentication number transmitted to the user via the transmission channel to validate the user's response and authenticate the user.

In various embodiments, tokenization system 150 may be configured to generate and/or provide a unique identifier for use with the payment transfer. For example, tokenization system 150 may generate the unique identifier in response to a user initiating a payment transfer via UI 125. Tokenization system 150 may generate the unique identifier using any suitable or desired technique or process. Tokenization system 150 may transmit the unique identifier to decisioning processor 130. The unique identifier may be used to identify and/or track the payment transfer throughout processing of the payment. The unique identifier may comprise any suitable ID, number, digital token, and/or the like unique to a payment transfer. In various embodiments, tokenization system 150 may generate the unique identifier to be compatible with legacy systems and environments used by financial institutions, issuer systems, banks, and/or the like. In that regard, system 100 may be compatible with preexisting systems and computing environments without needing to introduce a new identification system. For example, the unique identifier may comprise a checking account number, a savings account number, a credit card number, a commercial account number, a commercial charge card number, a direct deposit account number, and/or any other number or identifier previously existing in a legacy system (e.g., a legacy identifier).

Tokenization system 150 may be in electronic communication with decisioning processor 130. Tokenization system 150 may comprise may comprise one or more hardware, software, and/or database components. For example, tokenization system 150 may comprise one or more network environments, servers, computer-based systems, processors, databases, and/or the like. Tokenization system 150 may comprise at least one computing device in the form of a computer or processor, or a set of computers/processors, although other types of computing units or systems may be used such as, for example, a server, web server, pooled servers, or the like. Tokenization system 150 may also include software, such as services, APIs, SDKs, and the like, configured to perform various tokenization operations discussed herein. In various embodiments, tokenization system 150 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, risk and fraud assessment platform 140 may be configured to perform one or more risk and/or fraud assessments on a payment request. Risk and fraud assessment platform 140 may be in electronic communication with UI 125 and/or decisioning processor 130. Risk and fraud assessment platform 140 may comprise may comprise one or more hardware, software, and/or database components. For example, risk and fraud assessment platform 140 may comprise one or more network environments, servers, computer-based systems, processors, databases, and/or the like. Risk and fraud assessment platform 140 may comprise at least one computing device in the form of a computer or processor, or a set of computers/processors, although other types of computing units or systems may be used such as, for example, a server, web server, pooled servers, or the like. Risk and fraud assessment platform 140 may also include software, such as services, APIs, SDKs, and the like, configured to perform various tokenization operations discussed herein. In various embodiments, risk and fraud assessment platform 140 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

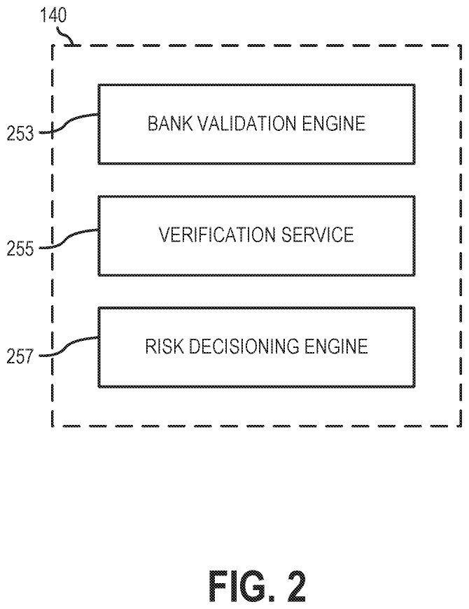

In various embodiments, risk and fraud assessment platform 140 may comprise various systems, engines, interfaces, and the like configured to provide risk and fraud assessment capabilities, as discussed further herein. For example, and with reference to FIG. 2, risk and fraud assessment platform 140 may comprise a bank validation engine 253, a verification service 255, and/or a risk decisioning engine 257. Each service, engine, or the like may be implemented by various means depending upon applications according to particular examples. For example, such methodologies may be implemented in hardware, firmware, software, or combinations thereof. In a hardware implementation, for example, a controller or processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof. In a software implementation, for example, various web services, APIs, SDKs, or the like may be configured to perform the various operations described herein.

In various embodiments, bank validation engine 253 may be configured to validate, verify, and authenticate the user's input bank information and provide sender bank data (e.g., captured sender bank data) for fraud and risk assessment. Bank validation engine 253 may be configured to validate the user bank data. Bank validation engine 253 may validate the user bank data using any suitable process or technique. For example, bank validation engine 253 may be in electronic communication with one or more sender banks 193, and may be configured to communicate with each sender bank 193 to validate, verify, and authenticating user bank data from the payment transfer data. In various embodiments, the user bank data validation may comprise verifying and validating the sender bank login information input by the user to authenticate the user, determine the account that the user desires to withdraw money form, validate that the account has sufficient funds to complete the transaction, and/or the like. Bank validation engine 253 may return to risk decisioning engine 257 data indicating whether the sender bank data is validated and whether the account is capable of transferring the money to the receiver (e.g., “pass,” “fail,” “insufficient funds,” etc.). The user bank data validation may also return data associated with the user, such as name, address, phone number, email address, address data, or the like. The user bank data validation may also return data associated with the bank being used for the withdrawal, such as bank name, account name, account type, account number, accounting routing number, and/or the like. In various embodiments, bank validation engine 253 may comprise a financial services integration service, such as the PLAID® software offered by Plaid, Inc.

In various embodiments, verification service 255 may be configured to perform one or more fraud detection operations. For example, verification service 255 may be configured to perform a risk assessment on user device 110 to determine a likelihood that user device 110, an email account for the user submitting the payment request, or the like, has been compromised by a third party. As discussed further herein, verification service 255 may be configured to capture the user device characteristics (e.g., captured user device data) from user device 110 in response to the user initiating a payment transfer. Verification service 255 may be configured to capture the user device characteristics by executing an XML script configured to retrieve and capture the user device characteristics from user device 110. As discussed further herein, verification service 255 may transmit the captured user device characteristics to risk decisioning engine 257.

In various embodiments, verification service 255 may comprise a mobile device authentication and fraud prevention software solution, such as the INAUTH SECURITY PLATFORM™ offered by InAuth, Inc. The mobile device authentication and fraud prevention software solution may provide additional fraud detection services, such as, for example, the generation of a fraud score based on captured user device data.

In various embodiments, risk decisioning engine 257 may be configured to execute a risk and fraud decisioning process to determine whether communications, including the payment request, from the user (via user device 110) are fraudulent and/or carry a risk of the user having insufficient funds to complete the transaction. Risk decisioning engine 257 may perform the risk and fraud decisioning process based on the transaction data, the captured sender bank data, the captured user device data, and/or any other suitable or desired data.

For example, in response to receiving the captured user device data from verification service 255, risk decisioning engine 257 may be configured to perform various operations on the captured user device data to determine whether the captured user device data indicates possible fraud. For example, risk decisioning engine 257 may retrieve or query historical transaction fraud data. The historical transaction fraud data may comprise various device data characteristics known to originate from fraudulent sources, fraud rates associated with the device data, and/or the like. In that regard, risk decisioning engine 257 may compare the captured user device data against the historical transaction fraud data to determine whether the captured user device data comprises data known to originate from a fraudulent source. For example, in response to the historical transaction fraud data comprising a low fraud rate (or not existing), risk decisioning engine 257 may determine that the captured user device data is not from a fraudulent source. In response to the historical transaction fraud data matching the captured user device data and having a high fraud rate, risk decisioning engine 257 may determine that the captured user device data is from a fraudulent source.

As a further example, and in accordance with various embodiments, risk decisioning engine 257 may comprise if-then logic configured to determine whether the captured user device data indicates possible fraud. The if-then logic may comprise various fraud thresholds corresponding to one or more of the captured user device data. For example, an exemplary if-then logic may comprise, “if the captured IP address has been captured more than 5 times in one day, then the transaction is fraudulent,” “if the screen resolution setting is low and the enabled language is French, then the transaction is fraudulent,” and/or any other suitable if-then logic.

As a further example, and in accordance with various embodiments, risk decisioning engine 257 may implement statistical models, machine learning, artificial intelligence, and the like to aid in identifying possible fraud. In that regard, the captured user device data may be input into the statistical model, the machine learning model, or the artificial intelligence model to determine a risk of fraud. For example, and in accordance with various embodiments, a model may consume the captured user device data, the historical transaction fraud data, and/or non-device related attributes (e.g., a risk level of transaction, a time of day, maintenance activity on the transaction account, etc.). Based on the data consumption, the model may be leveraged to predict whether the payment request is originating from a fraudulent device.

Risk decisioning engine 257 may be configured to classify the determination of fraud by generating a risk assessment. The risk assessment may comprise any suitable scale, such as, for example, “low risk,” “medium risk,” or “high risk;” a numerical value; or the like. For example, a “high risk” risk assessment may be determined in response to bank validation engine 253 determining the user account does not have sufficient funds and verification service 255 capturing user device characteristics indicating a fraudulently obtained user device was used to initiate the payment transfer. As a further example, a “medium risk” may be determined in response to bank validation engine 253 verifying the user account and validating that the user account comprises sufficient funds to complete the payment transfer and verification service 255 capturing user device characteristics indicating that the payment transfer may have been fraudulently initiated. As a further example, a “low risk” may be determined in response to bank validation engine 253 verifying the user account and validating that the user account comprises sufficient funds to complete the payment transfer and verification service 255 capturing user device characteristics indicating that the payment transfer was not fraudulently initiated.

Risk decisioning engine 257 may transmit the risk assessment to decisioning processor 130. Decisioning processor 130 may be configured to decline or authorize the payment transfer, and/or require additional authentication, in response to receiving the risk assessment, as discussed further herein.

In various embodiments, and with reference again to FIG. 1, payment processor 160 may be configured to process the payment transfer. For example, in response to decisioning processor 130 authorizing the payment transfer, decisioning processor 130 may transmit a payment processing request to payment processor 160. As discussed further herein, payment processor 160 may complete the payment processing request by debiting funds from sender bank 193 and crediting funds to receiver bank 195. Payment processor 160 may be in electronic communication with decisioning processor 130, sender bank 193, and/or receiver bank 195.

Payment processor 160 may comprise may comprise one or more hardware, software, and/or database components. For example, payment processor 160 may comprise one or more network environments, servers, computer-based systems, processors, databases, and/or the like. Payment processor 160 may comprise at least one computing device in the form of a computer or processor, or a set of computers/processors, although other types of computing units or systems may be used such as, for example, a server, web server, pooled servers, or the like. Payment processor 160 may also include software, such as services, APIs, SDKs, and the like, configured to perform various tokenization operations discussed herein. In various embodiments, payment processor 160 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

Sender bank 193 may comprise a financial institution, bank, or the like that the user (e.g., the sender) has a transaction account with. For example, sender bank 193 may comprise and maintain a transaction account, such as a checking account, savings account, or the like, that the user desires to use to transmit funds from. As discussed further herein, sender bank 193 may be configured to debit a transaction account associated with the user in response to receiving instructions from payment processor 160. Receiver bank 195 may comprise a financial institution, bank, or the like that the merchant (e.g., the receiver) has a transaction account, merchant account, or the like with. For example, receiver bank 195 may comprise and maintain a transaction account, merchant payable account, or the like that the merchant desires to use to receive funds as part of the payment transfer. As discussed further herein, receiver bank 195 may be configured to credit the account associated with the merchant in response to receiving instructions from payment processor 160.

In various embodiments, sender bank 193 and receiver bank 195 may comprise different banks or financial institutions. In various embodiments, sender bank 193 and receiver bank 195 may comprise the same bank or financial institution, or separate banks or financial institutions in partnership with each other.

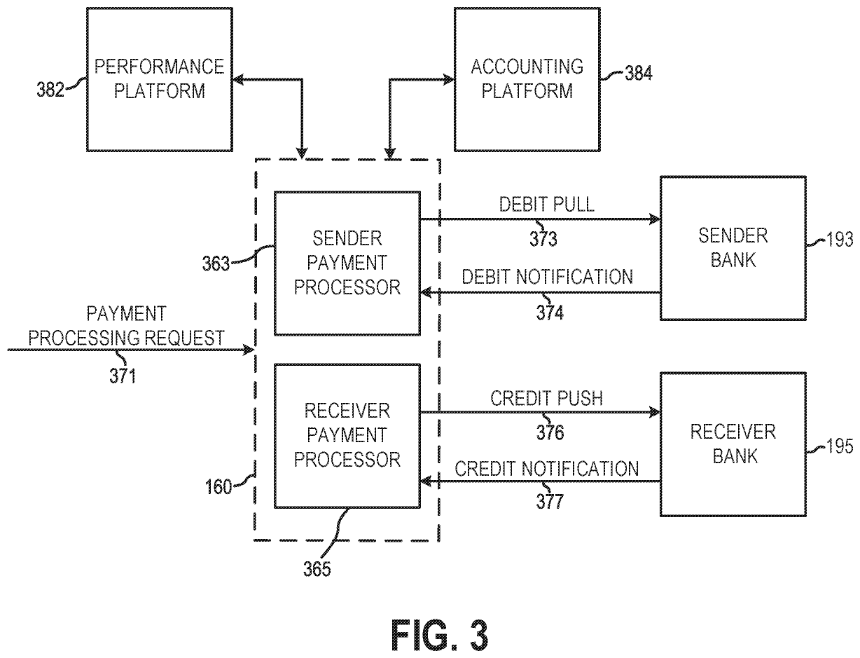

In various embodiments, payment processor 160 may comprise various systems, engines, interfaces, and the like configured to provide risk assessment and/or fraud assessment capabilities, as discussed further herein. For example, and with reference to FIG. 3, payment processor 160 may comprise a sender payment processor 363 and/or a receiver payment processor 365. Each processor may be implemented by various means depending upon applications according to particular examples. For example, such methodologies may be implemented in hardware, firmware, software, or combinations thereof. In a hardware implementation, for example, a controller or processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof. In a software implementation, for example, various web services, APIs, SDKs, or the like may be configured to perform the various operations described herein.

In various embodiments, in response to payment processor 160 receiving a payment processing request 371 (e.g., from decisioning processor 130), payment processor 160 may invoke sender payment processor 363 and receiver payment processor 365 to complete the payment transfer. The payment processing request 371 may comprise data regarding the payment transfer, such as, for example, sender data, receiver data, and/or transaction data. The sender data may comprise data regarding the sender bank (e.g., account number, routing number, ACH routing number, name on the account, etc.), data regarding the sender (e.g., name, address, phone number, etc.), and/or any other data corresponding to the sender. The receiver data may comprise data regarding the receiver bank (e.g., account number, routing number, ACH routing number, name or business on the account, etc.), data regarding the receiver (e.g., merchant name or ID, address, phone number, etc.), and/or any other data corresponding to the receiver. The transaction data may comprise the unique identifier (e.g., as assigned by tokenization system 150), a transaction amount, and/or any other transaction data.

Payment processor 160 may invoke sender payment processor 363 to debit the transaction amount from the sender's transaction account at sender bank 193, and may invoke receiver payment processor 365 to credit the transaction amount to the receiver's transaction account at receiver bank 195. In various embodiments, payment processor 160 may invoke each processor simultaneously, or near simultaneously (e.g., within a time period of close proximity), such that the funds may be withdrawn from the sender's account and credited to the receiver's account at the same time, or near same time, and the same day of the payment transfer (e.g., in contrast to typical payment platforms requiring a delay to ensure funds are properly withdrawn from the sender's account). For example, a debit pull may be transmitted at a first time and a credit push may be transmitted at a second time. The first time may be the same or proximate the second time.

Sender payment processor 363 may comprise various components, systems, engines, or the like configured to enable payment processor 160 to debit funds from the sender's account at sender bank 193. For example, sender payment processor 363 may comprise a remittance system, an accounts receivable system, or the like. In various embodiments, the subsystem components of sender payment processor 363 may be dependent on the financial institution, issuer system, or the like operating payment processor 160.

In response to being invoked, sender payment processor 363 may be configured to generate and transmit a debit pull 373 to sender bank 193. The debit pull 373 may initiate the withdrawal of funds from sender bank 193. For example, the debit pull 373 may comprise an ACH pull to withdraw the transaction amount from the sender account at sender bank 193. The debit pull 373 may comprise data regarding the sender (e.g., sender bank data, sender name, sender address, etc.) and the debit amount (e.g., based on the transaction amount).

In response to receiving the debit pull 373, sender bank 193 may initiate withdrawal of the debit amount from the sender's account. In response to initiating the debit, sender bank 193 may transmit back a debit notification 374 to sender payment processor 363. The debit notification 374 may comprise data indicating that the debit was initiated and/or completed successfully.

Receiver payment processor 365 may comprise various components, systems, engines, or the like configured to enable payment processor 160 to credit funds to the receiver's account at receiver bank 195. For example, sender payment processor 363 may comprise a submissions system, a payment services system, a messaging real time capture system, a merchant system, and/or the like. In various embodiments, the subsystem components of receiver payment processor 365 may be dependent on the financial institution, issuer system, or the like operating payment processor 160.

In response to being invoked, receiver payment processor 365 may be configured to generate and transmit a credit push 376 to receiver bank 195. The credit push 376 may be configured to initiate the transmission of funds to receiver bank 195. For example, the credit push 376 may comprise an ACH push to transmit the transaction amount to the receiver account at receiver bank 195. The credit push 376 may comprise data regarding the receiver (e.g., receiver bank data, receiver business data, etc.) and the credit amount (e.g., based on the transaction amount).

In response to receiving the credit push 376, receiver bank 195 may initiate transmission of the credit amount to the receiver's account. In response to initiating the credit, receiver bank 195 may transmit back a credit notification 377 to receiver payment processor 365. The credit notification 377 may comprise data that the credit was initiated and/or completed successfully.

In various embodiments, receiver payment processor 365 may withdraw the credit amount from a system repository. For example, in response to payment processor 160 being part of a payment network, issuer system, financial institution, or the like, payment processor 160 may with the credit amount from a bank, system repository, or the like owned or ran by the payment network, issuer system, financial institution, or the like. In response to receiving the debit funds from sender bank 193, the system may reconcile and replenish the funds withdrawn for the credit push 376.

In various embodiments, in response to invoking sender payment processor 363 and receiver payment processor 365 and initiating the debit pull 373 and the credit push 376, payment processor 160 may transmit a payment notification to merchant system 120. The payment notification may comprise the unique identifier and data, metadata, or the like indicating that the payment transfer was completed successfully. In various embodiments, the debit pull 373, the credit push 376, and the payment notification may be transmitted simultaneously, or near simultaneously (e.g., proximate in time to each other).

In various embodiments, payment processor 160 may also be in electronic communication with a performance platform 382 and/or accounting platform 384. Payment processor 160 may be configured to transmit data to each platform during the payment process.

Performance platform 382 may be configured to perform one or more performance and/or analytical operations based on the payment transfer process. For example, performance platform 382 may track payment transfers to determine the number of payments that are successfully completed or abandoned. For example, a completed payment may comprise data from the debit notification and the credit notification indicating that the payment was successfully debited and credited. An abandoned payment may not comprise at least one of the debit notification or the credit notification. In response to determining that a payment transfer was abandoned, performance platform 382 may be configured to gather data regarding the abandonment, such as, for example, the step in the process that the payment was abandoned, the reason for the abandonment (e.g., insufficient funds, user abortion, system error, etc.), and/or the like. In that respect, performance platform 382 may store and maintain data regarding the performance of system 100 and the success of the payment transfer process. Performance platform 382 may also be configured to perform any other desired performance and/or analytical operations.

Accounting platform 384 may be configured to provide accounting services for the processed payment transfers. For example, payment processor 160 may be configured to transmit the payment processing request 371, the debit pull 373, the debit notification 374, the credit push 376, and/or the credit notification 377 to accounting platform 384. Payment processor 160 may transmit the data in real time, in response to completing the payment transfer, or at any other suitable or desired time interval. Accounting platform 384 may be configured to track and maintain the data, and perform operations to ensure that the payment was successfully completed. For example, accounting platform 384 may be configured to track the payment to ensure that the debit amount from sender bank 193 is equal to the credit amount to receiver bank 195, and that the necessary funds were successfully withdrawn and deposited. In various embodiments, accounting platform 384 may also ensure that the debit amount received from sender bank 193 is equal to the funds withdrawn to provide the credit amount to receiver bank 195. In that respect, accounting platform 384 may reconcile the funds withdrawn and deposited to ensure that the full debit amount was received. Accounting platform 384 may also perform any other desired accounting processes based on the payment transfer.

In various embodiments, and with reference again to FIG. 1, one or more system 100 components may be part of a payment network and/or issuer system. For example, one or more of decisioning processor 130, tokenization system 150, risk and fraud assessment platform 140, and/or payment processor 160 may be part of the payment network and/or issuer system.

In various embodiments, the payment network and/or the issuer system may comprise any suitable combination of hardware, software, and/or database components. For example, the payment network and/or the issuer system may comprise one or more network environments, servers, computer-based systems, processors, databases, and/or the like. The payment network and/or the issuer system may comprise at least one computing device in the form of a computer or processor, or a set of computers/processors, although other types of computing units or systems may be used, such as, for example, a server, web server, pooled servers, or the like. The payment network and/or the issuer system may also include one or more data centers, cloud storages, or the like, and may include software, such as APIs, configured to perform various operations discussed herein. In various embodiments, the payment network and/or the issuer system may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, the payment network and/or the issuer system may comprise or interact with a traditional payment network or transaction network to facilitate purchases and payments, authorize transactions, settle transactions, and the like. For example, the payment network and/or the issuer system may represent existing proprietary networks that presently accommodate transactions for credit cards, debit cards, and/or other types of transaction accounts or transaction instruments. The payment network and/or the issuer system may be a closed network that is secure from eavesdroppers. In various embodiments, the payment network and/or the issuer system may comprise an exemplary transaction network such as AMERICAN EXPRESS®, VISANET®, MASTERCARD®, DISCOVER®, INTERAC®, Cartes Bancaires, JCB®, private networks (e.g., department store networks), and/or any other payment network, transaction network, issuer system, or the like. The payment network and/or the issuer system may include systems and databases related to financial and/or transactional systems and processes, such as, for example, one or more authorization engines, authentication engines and databases, settlement engines and databases, accounts receivable systems and databases, accounts payable systems and databases, and/or the like. In various embodiments, the payment network and/or the issuer system may also comprise a transaction account issuer's Credit Authorization System (“CAS”) capable of authorizing transactions, as discussed further herein. The payment network and/or the issuer system may be configured to authorize and settle transactions, and maintain transaction account member databases, accounts receivable databases, accounts payable databases, or the like.

Although the present disclosure makes reference to the payment network and/or the issuer system, it should be understood that principles of the present disclosure may be applied to a system for processing payment transfers having any suitable number of payment networks and/or issuer systems. For example, system 100 may comprise one or more the payment network and/or the issuer system, each having various system 100 components, and each corresponding to or associated with a different issuer system or network.

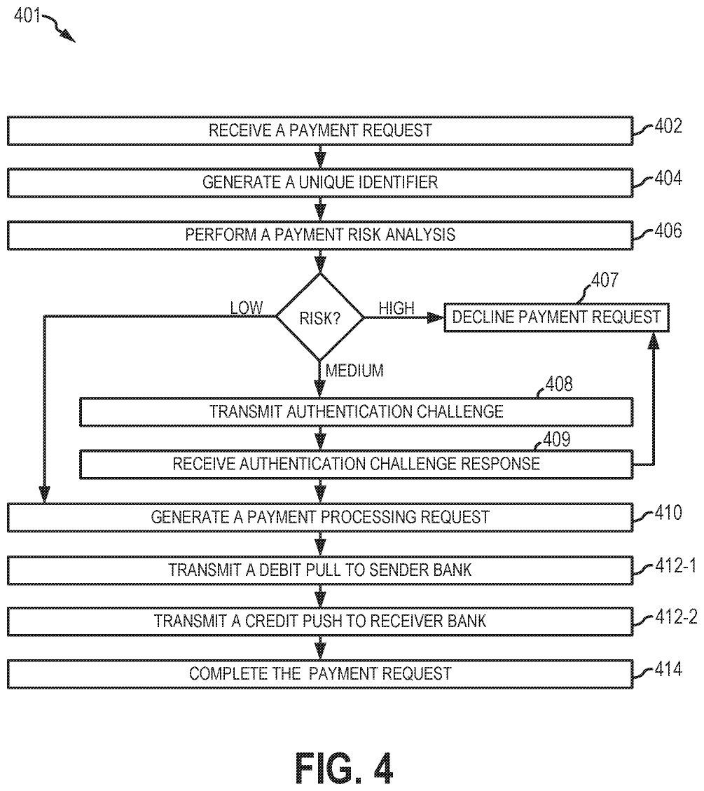

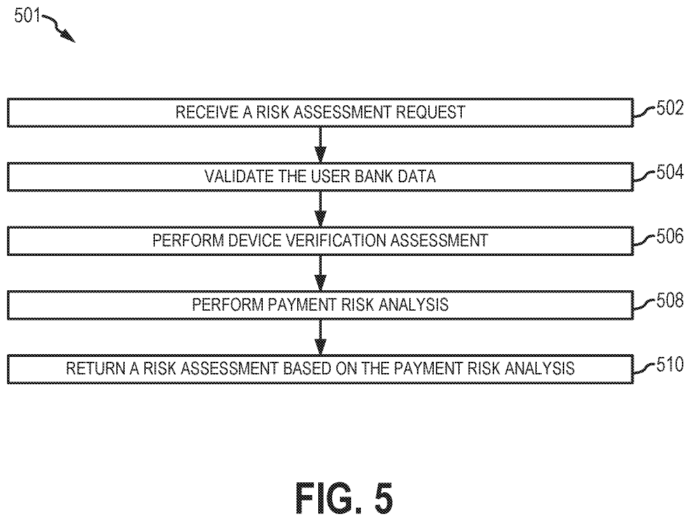

Referring now to FIGS. 4 and 5 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 4 and 5, but also to the various system components as described above with reference to FIGS. 1-3. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

In various embodiments, and with specific reference to FIG. 4, a method 401 for processing payment transfers is disclosed. Method 401 may enable a user (e.g., the sender) to transfer money to a merchant (e.g., the receiver) to complete a transaction with the merchant. Method 401 may allow the merchant to receive the transfer in real time, or near real time, and without needing the parties to have special software or hardware to participate, such as common transfer platform (e.g., in contrast to common transfer platforms offered by PAYPAL®, ZELLE®, etc.).

Method 401 may include receiving a payment request (step 402). The payment request may comprise sender data, receiver data, and/or transaction data. The sender data may comprise data corresponding to the user submitting the payment request, such as, for example, sender bank data (e.g., account number, routing number, ACH routing number, name on the account, etc.), sender personal data (e.g., name, address, phone number, etc.), and/or the like. The receiver data may comprise data corresponding to the merchant receiving the payment transfer, such as, for example, receiver bank data (e.g., account number, routing number, ACH routing number, name or business on the account, etc.), receiver business data (e.g., merchant name or ID, address, phone number, etc.), and/or any other data corresponding to the receiver. The transaction data may comprise data corresponding to the transaction, such as, for example, the transaction amount, transaction terms, and/or any other suitable transaction data.

In various embodiments, a user may interact with UI 125, via user device 110, to initiate the payment request. For example, the user may interact with merchant system 120, via UI 125, to purchase goods and/or services available from the merchant. In response to initiating a transaction with merchant system 120, the user may input or select to complete the transaction using the payment transfer. In response to UI 125 receiving the user input or selection, UI 125, alone or via decisioning processor 130, may invoke risk and fraud assessment platform 140 to present a payment window via UI 125. For example, the payment window may be loaded as an iFrame, or using any other suitable display window. The payment window may prompt the user to input details about the sender bank the user desires to use to complete the payment transfer. For example, the payment window may prompt the user to select a bank (e.g., CHASE®, WELLS FARGO®, BANK OF AMERICA®, etc.), input bank-specific login credentials (e.g., username, password, PIN, biometric input, etc.), confirm payment details (e.g., the user account to withdraw the payment from, the name of the merchant to receive the payment, the payment amount, etc.), and/or the like. In various embodiments, the bank-specific login credentials may be verified by risk and fraud assessment platform 140, via bank validation engine 253, in response to the user inputting the bank-specific login credentials (e.g., step 504 of method 501, with brief reference to FIG. 5, and as discussed further herein).

Method 401 may comprise generating a unique identifier (step 404). For example, in response to receiving the payment request, decisioning processor 130 may invoke tokenization system 150 to generate the unique identifier. The unique identifier may be generated using any suitable method, and may be assigned to the payment transfer to track the payment transfer through completion of the transaction. In response to generating the unique identifier, tokenization system 150 may transmit the unique identifier to decisioning processor 130. Decisioning processor 130 may append the unique identifier to the payment request. In that regard, the payment request may be identified, stored, and maintained throughout the process using the unique identifier.

Method 401 may comprise performing a risk analysis (step 406) on the payment request. For example, decisioning processor 130 may invoke risk and fraud assessment platform 140 to complete the risk analysis. Decisioning processor 130 may invoke risk and fraud assessment platform 140 by transmitting the payment request to risk and fraud assessment platform 140. In various embodiments, risk and fraud assessment platform 140 may also previously receive at least a portion of the payment transfer data, such as, for example in response to bank validation engine 253 being used to validate the sender bank data. Risk and fraud assessment platform 140 may perform the risk analysis using any suitable technique or process. For example, in accordance with various embodiments and with specific reference to FIG. 5, a method 501 for analyzing risk in a payment transfer is disclosed.

Method 501 may comprise receiving a risk assessment request (step 502). Risk and fraud assessment platform 140 may receive the risk assessment request from decisioning processor 130. The risk assessment request may comprise the payment transfer data. In response to receiving the risk assessment request, risk and fraud assessment platform 140 may be configured to perform various risk and/or fraud assessments to determine whether the payment transfer was initiated fraudulently, whether the user has sufficient funds to complete the payment transfer, and/or the like.

Method 501 may comprise validating the user bank data (step 504) from the payment transfer data. Bank validation engine 253 may be configured to validate the user bank data. Bank validation engine 253 may validate the user bank data using any suitable process or technique. For example, bank validation engine 253 may be in electronic communication with one or more sender banks 193, and may be configured to communicate with each sender bank 193 to validate and verify user bank data from the payment transfer data. In various embodiments, the user bank data validation may comprise verifying and validating the sender bank login information input by the user to determine the account that the user desires to withdraw money form, validating that the account has sufficient funds to complete the transaction, and/or the like. Bank validation engine 253 may return to risk decisioning engine 257 data indicating whether the sender bank data is validated and whether the account is capable of transferring the money to the receiver (e.g., “pass,” “fail,” “insufficient funds,” etc.). The user bank data validation may also return data associated with the user, such as name, address, phone number, email address, or the like, to be used for further user verification.

Method 501 may comprise performing a device verification assessment (step 506). For example, verification service 255 may be configured to perform the device verification assessment on user device 110. The device verification assessment may be performed to determine a likelihood that user device 110, an email account for the user submitting the payment request, or the like, has been compromised by a third party. In various embodiments, in response to the user inputting the payment request (e.g., step 402, with brief reference to FIG. 4) verification service 255 may be configured to capture the user device characteristics (e.g., captured user device data) from user device 110. In various embodiments, verification service 255 may be configured to capture the user device characteristics in response to decisioning processor 130 invoking risk and fraud assessment platform 140 to complete the risk assessment. The captured user device characteristics may correspond to software, hardware, and/or physical parameters and settings of user device 110 used by the user to submit the payment request. For example, user device 110 may comprise a unique device ID, an IP address, an operating system type (e.g., WINDOWS®, ANDROID®, APPLE® IOS®, LINUX®, etc.), a web browser type (e.g., MICROSOFT INTERNET EXPLORER®, GOOGLE CHROME®, etc.), an enabled language (e.g., English, Spanish, Italian, etc.), a screen resolution setting, scripting settings (e.g., JAVACRIPT® enabled web browser), an anonymous IP indicator, and/or the like. Verification service 255 may transmit the captured user device characteristics to risk decisioning engine 257.

Method 501 may comprise performing a payment risk analysis (step 508). Risk decisioning engine 257 may be configured to perform and execute the payment risk analysis. The payment risk analysis may be based on at least one of the transaction data from the payment request, the user bank data validation, and/or the captured user device characteristics. For example, in response to receiving the captured user device characteristics from verification service 255, risk decisioning engine 257 may be configured to perform various operations on the captured user device characteristics to determine whether the captured user device characteristics indicates possible fraud. For example, risk decisioning engine 257 may retrieve or query historical transaction fraud data. The historical transaction fraud data may comprise various device data characteristics known to originate from fraudulent sources, fraud rates associated with the device data, and/or the like. In that regard, risk decisioning engine 257 may compare the captured user device characteristics against the historical transaction fraud data to determine whether the captured user device characteristics comprises data known to originate from a fraudulent source. For example, in response to the historical transaction fraud characteristics comprising a low fraud rate (or not existing), risk decisioning engine 257 may determine that the captured user device characteristics is not from a fraudulent source. In response to the historical transaction fraud data matching the captured user device characteristics and having a high fraud rate, risk decisioning engine 257 may determine that the captured user device characteristics is from a fraudulent source.

As a further example, and in accordance with various embodiments, risk decisioning engine 257 may comprise if-then logic configured to determine whether the captured user device characteristics indicates possible fraud. The if-then logic may comprise various fraud thresholds corresponding to one or more of the captured user device characteristics. For example, an exemplary if-then logic may comprise, “if the captured IP address has been captured more than 5 times in one day, then the transaction is fraudulent,” “if the screen resolution setting is low and the enabled language is French, then the transaction is fraudulent,” and/or any other suitable if-then logic.

As a further example, and in accordance with various embodiments, risk decisioning engine 257 may implement statistical models, machine learning, artificial intelligence, and the like to aid in identifying possible fraud. In that regard, the captured user device characteristics may be input into the statistical model, the machine learning model, or the artificial intelligence model to determine a risk of fraud. For example, and in accordance with various embodiments, a model may consume the captured user device characteristics, the historical transaction fraud data, and/or non-device related attributes (e.g., a risk level of transaction, a time of day, maintenance activity on the transaction account, etc.). Based on the data consumption, the model may be leveraged to predict whether the payment request is originating from a fraudulent device.

Risk decisioning engine 257 may be configured to classify the determination of fraud by generating a risk assessment. The risk assessment may comprise any suitable scale, such as, for example, “low risk,” “medium risk,” or “high risk;” a numerical value; or the like. For example, a “high risk” risk assessment may be determined in response to bank validation engine 253 determining the user account does not have sufficient funds and verification service 255 capturing user device characteristics indicating a fraudulently obtained user device was used to initiate the payment transfer. As a further example, a “medium risk” may be determined in response to bank validation engine 253 verifying the user account and validating that the user account comprises sufficient funds to complete the payment transfer and verification service 255 capturing user device characteristics indicating that the payment transfer may have been fraudulently initiated. As a further example, a “low risk” may be determined in response to bank validation engine 253 verifying the user account and validating that the user account comprises sufficient funds to complete the payment transfer and verification service 255 capturing user device characteristics indicating that the payment transfer was not fraudulently initiated.

Method 501 may comprise returning the risk assessment based on the payment risk analysis (step 510). Risk decisioning engine 257 may be configured to return the payment risk analysis to decisioning processor 130.

In various embodiments, and with reference again to FIG. 4, method 401 may comprise determining the risk level of the payment risk analysis. Decisioning processor 130 may be configured to determine the risk level based on the payment risk analysis returned by risk and fraud assessment platform 140.

In response to the risk comprising a “high risk,” method 401 may comprise declining the payment request (step 407). Decisioning processor 130 may transmit a payment declined notification to user device 110, via UI 125. The payment declined notification may comprise data indicating that the payment request was declined. In various embodiments, the payment declined notification may also prompt the user to select another form of payment to complete the transaction.

In response to the risk comprising a “medium risk,” method 401 may comprise transmitting an authentication challenge (step 408). Decisioning processor 130 may be configured to transmit the authentication challenge to user device 110 (e.g., directly and/or displayed via UI 125). The authentication challenge may be transmitted to user device 110 via any suitable transmission channel (e.g., SMS, MMS, email, push notification, phone call, etc.). The transmission channel may be selected by the user, or may be based on historic account or payment information associated with the user. The authentication challenge may comprise a multi-factor authentication challenge. For example, if the user had previously registered with system 100 using a biometric input, username and password, or the like, the authentication challenge may comprise data prompting the user to input the biometric input together with the user's password (e.g., a 2-factor authentication), via user device 110. The authentication challenge may comprise a two-factor authentication. Decisioning processor 130 may transmit an authentication number (e.g., a PIN, a code, a 6-digit number, a one-time password, etc.) via the transmission channel, and prompt the user to input the authentication number into UI 125, via user device 110.

Method 401 may comprise receiving an authentication challenge response (step 409) based on the authentication request. Decisioning processor 130 may receive the authentication challenge response from user device 110 (e.g., directly or via UI 125). Decisioning processor 130 may compare the authentication challenge response against stored biometric data, username and password data, authentication number, or the like to validate the user's response and authenticate the user.

In various embodiments, in response to the authentication challenge response failing validation (e.g., the authentication challenge response did not match the authentication challenge), decisioning processor 130 may be configured to transmit a second authentication challenge (or any other desired number of authentication challenges) before declining the payment request (e.g., step 407).

In various embodiments, in response to the risk comprising a “low risk” or in response to validating the authentication challenge response (e.g., step 409), method 401 may comprise generating a payment processing request (step 410). For example, in response to the risk comprising a “low risk” or in response to validating the authentication challenge response, decisioning processor 130 may be configured to generate the payment processing request 371 and invoke payment processor 160 by transmitting the payment processing request 371 to payment processor 160. The payment processing request 371 may comprise data regarding the payment transfer, such as, for example, sender data, receiver data, and/or transaction data. The sender data may comprise data regarding the sender bank (e.g., account number, routing number, ACH routing number, name on the account, etc.), data regarding the sender (e.g., name, address, phone number, etc.), and/or any other data corresponding to the sender. The receiver data may comprise data regarding the receiver bank (e.g., account number, routing number, ACH routing number, name or business on the account, etc.), data regarding the receiver (e.g., merchant name or ID, address, phone number, etc.), and/or any other data corresponding to the receiver. The transaction data may comprise the unique identifier (e.g., as assigned by tokenization system 150), a transaction amount, and/or any other transaction data.

In response to being invoked, payment processor 160 may invoke sender payment processor 363 to debit the transaction amount from the sender's account at sender bank 193, and may invoke receiver payment processor 365 to credit the transaction amount to the receiver's transaction account at receiver bank 195. In various embodiments, payment processor 160 may invoke each processor simultaneously, or near simultaneously (e.g., within a time period of close proximity), such that the funds may be withdrawn from the sender's account and credited to the receiver's account at the same time, or near same time, and the same day of the payment transfer (e.g., in contrast to typical payment platforms requiring a delay to ensure funds are properly withdrawn from the sender's account).

Method 401 may comprise transmitting a debit pull to a sender bank (step 412-1). For example, in response to being invoked, sender payment processor 363 may be configured to generate and transmit the debit pull 373 to sender bank 193. The debit pull 373 may initiate the withdrawal of funds from sender bank 193. For example, the debit pull 373 may comprise an ACH pull to withdraw the transaction amount from the sender account at sender bank 193. The debit pull 373 may comprise data regarding the sender (e.g., sender bank data, sender name, sender address, etc.) and the debit amount (e.g., based on the transaction amount). In various embodiments, the debit pull 373 may also comprise data associate with the system repository, bank, or the like that the credited funds are withdrawn from. In that respect, sender bank 193 may remit the debit amount to the system repository, bank, or the like to replenish the withdrawn funds.

In response to receiving the debit pull 373, sender bank 193 may initiate withdrawal of the debit amount from the sender's account. In response to initiating the debit, sender bank 193 may transmit back a debit notification 374 to sender payment processor 363. The debit notification 374 may comprise data indicating that the debit was initiated and/or completed successfully.

Method 401 may comprise transmitting a credit push to a receiver bank (step 412-2). For example, in response to being invoked, receiver payment processor 365 may be configured to generate and transmit a credit push 376 to receiver bank 195. The credit push 376 may be configured to initiate the transmission of funds to receiver bank 195. For example, the credit push 376 may comprise an ACH push to transmit the transaction amount to the receiver account at receiver bank 195. As discussed further herein, the transaction amount may be withdrawn from a system repository, bank, or the like, and replenished in response to receiving the debit amount from sender bank 193. The credit push 376 may comprise data regarding the receiver (e.g., receiver bank data, receiver business data, etc.) and the credit amount (e.g., based on the transaction amount).

In response to receiving the credit push 376, receiver bank 195 may initiate transmission of the credit amount to the receiver's account. In response to initiating the credit, receiver bank 195 may transmit back a credit notification 377 to receiver payment processor 365. The credit notification 377 may comprise data that the credit was initiated and/or completed successfully.

Method 401 may comprise completing the payment request (step 414). For example, and in accordance with various embodiments, in response decisioning processor 130 invoking payment processor 160 to transmit the debit pull 373 to sender bank 193 and the credit push 376 to receiver bank 195, decisioning processor 130 may transmit a payment confirmation to user device 110, directly or via UI 125, and/or to merchant system 120. In that respect, the payment confirmation may be transmitted simultaneously, or near simultaneously (e.g., proximate in time), as the debit pull 373 and the credit push 376 are transmitted. As a further example, and in accordance with various embodiments, the payment confirmation may also be transmitted at any other suitable time. For example, in response to receiving the debit notification 374 and the credit notification 377, payment processor 160 may return data to decisioning processor 130 indicating that the payment transfer was completed successfully. Decisioning processor 130 may transmit a payment confirmation to user device 110, directly or via UI 125, and/or to merchant system 120. In that regard, merchant system 120 and user device 110 may complete the transaction.

In various embodiments, in response to at least one of the debit pull 373 or the credit push 376 failing, payment processor 160 may return data to decisioning processor 130 indicating that the payment transfer failed. Decisioning processor 130 may transmit a payment declined notification to user device 110 (e.g., directly or displayed via UI 125). The payment declined notification may comprise data indicating that the payment request was declined or failed. In various embodiments, the payment declined notification may also prompt the user to select another form of payment to complete the transaction.

In various embodiments, in response to completing the payment request, and/or during the payment process, payment processor 160 may also transfer data to performance platform 382 and/or accounting platform 384 for analysis.

Performance platform 382 may be configured to perform one or more performance and/or analytical operations based on the payment transfer process. For example, performance platform 382 may track payment transfers to determine the number of payments that are successfully completed or abandoned. In response to determining that a payment transfer was abandoned, performance platform 382 may be configured to gather data regarding the abandonment, such as, for example, the step in the process that the payment was abandoned, the reason for the abandonment (e.g., insufficient funds, user abortion, system error, etc.), and/or the like.

Accounting platform 384 may be configured to provide accounting services for processed payment transfers. For example, payment processor 160 may be configured to transmit data regarding the payment processing request 371, the debit pull 373, the debit notification 374, the credit push 376, and/or the credit notification 377 to accounting platform 384. Accounting platform 384 may be configured to track and maintain the data, and perform operations to ensure that the payment was successfully completed. For example, accounting platform 384 may be configured to track the payment to ensure that the debit amount from sender bank 193 is equal to the credit amount to receiver bank 195, and that the necessary funds were successfully withdrawn and deposited.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “transmit” may include sending at least a portion of electronic data from one system 100 component to another. Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system 100 components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system 100 components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system 100 may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward, discount, etc.) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “eBook,” an “eMagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS' applications but have been combined for simplicity.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer-based system, such as the operating system, database, applications, and the like. Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

In various embodiments, the server may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems).

Users, systems, computer-based systems or the like may communicate with the server via a web client. The web client includes any device or software which communicates via any network such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, U.S. application Ser. No. 15/943,271 titled FRAUD MANAGEMENT USING A DISTRIBUTED DATABASE and filed on Apr. 2, 2018, U.S. application Ser. No. 16/012,598 titled BUYER-CENTRIC MARKETPLACE USING BLOCKCHAIN and filed on Jun. 19, 2018, U.S. application Ser. No. 16/051,126 titled System and Method for Transaction Account Based Micro-Payments and filed on Jul. 31, 2018, and U.S. application Ser. No. 16/052,416 titled PROCUREMENT SYSTEM USING BLOCKCHAIN and filed on Aug. 1, 2018, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPE”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, any other application server components or may reside within another computing device or may take the form of a standalone hardware component.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, mechanical, electrical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
executing, by a processor, a payment risk analysis on a payment request, wherein the payment request comprises sender data, receiver data and a payment amount, and wherein the payment risk analysis determines a risk assessment associated with the payment request;
generating, by the processor, a payment processing request in response to the risk assessment comprising a low risk;
transmitting, by the processor and based on the payment processing request, a debit pull to a sender bank from the sender data, wherein in response to receiving the debit pull the sender bank debits the payment amount from a sender account from the sender data; and
transmitting, by the processor and based on the payment processing request, a credit push to a receiver bank from the receiver data, wherein in response to receiving the credit push the receiver bank credits the payment amount to a receiver account from the receiver data.

2. The method of claim 1, wherein the debit pull and the credit push are transmitted simultaneously or near simultaneously.

3. The method of claim 1, further comprising:
transmitting, by the processor, an authentication challenge in response to the risk assessment comprising a medium risk;
receiving, by the processor, an authentication challenge response based on the authentication challenge; and
validating, by the processor, the authentication challenge response by comparing the authentication challenge to the authentication challenge response.

4. The method of claim 1, further comprising declining, by the processor, the payment request in response to the risk assessment comprising a high risk.

5. The method of claim 1, wherein the executing the payment risk analysis comprises validating, by the processor, sender bank data from the sender data, wherein the sender bank data is validated by verifying sender bank login information from the sender bank data and validating that the sender account comprises sufficient funds to complete the payment request based on the payment amount.

6. The method of claim 1, wherein the executing the payment risk analysis comprises:
capturing, by the processor, a user device characteristic from a user device; and
determining, by the processor, the risk assessment by comparing the user device characteristic to historical transaction fraud data.

7. The method of claim 1, further comprising assigning, by the processor, a unique identifier to the payment request.

8. The method of claim 7, wherein the unique identifier comprises a legacy identifier compatible with a legacy payment system, and wherein the legacy identifier comprises a checking account number, a savings account number, a credit card number, a commercial account number a commercial charge card number, or a direct deposit account number.

9. The method of claim 1, further comprising approving, by the processor, the payment request in response to receiving a debit notification from the sender bank and a credit notification from the receiver bank.

10. The method of claim 9, wherein the payment request is initiated between a customer and a merchant as payment for a transaction, and wherein in response to the debit pull and the credit push being transmitted the merchant completes the transaction with the customer.

11. A system comprising:
a processor; and
a tangible, non-transitory memory configured to communicate with the processor, the tangible, non-transitory memory having instructions stored thereon that, in response to execution by the processor, cause the processor to perform operations comprising:
executing, by the processor, a payment risk analysis on a payment request, wherein the payment request comprises sender data, receiver data, and a payment amount, and wherein the payment risk analysis determines a risk assessment associated with the payment request;
generating, by the processor, a payment processing request in response to the risk assessment comprising a low risk;
transmitting, by the processor and based on the payment processing request, a debit pull to a sender bank from the sender data, wherein in response to receiving the debit pull the sender bank debits the payment amount from a sender account from the sender data; and
transmitting, by the processor and based on the payment processing request, a credit push to a receiver bank from the receiver data, wherein in response to receiving the credit push the receiver bank credits the payment amount to a receiver account from the receiver data.

12. The system of claim 11, further comprising:
transmitting, by the processor, an authentication challenge in response to the risk assessment comprising a medium risk;
receiving, by the processor, an authentication challenge response based on the authentication challenge; and
validating, by the processor, the authentication challenge response by comparing the authentication challenge to the authentication challenge response.

13. The system of claim 11, further comprising declining, by the processor, the payment request in response to the risk assessment comprising a high risk.

14. The system of claim 11, wherein the executing the payment risk analysis comprises validating, by the processor, sender bank data from the sender data, wherein the sender bank data is validated by verifying sender bank login information from the sender bank data and validating that the sender account comprises sufficient funds to complete the payment request based on the payment amount.

15. The system of claim 11, wherein the executing the payment risk analysis comprises:
capturing, by the processor, a user device characteristic from a user device; and
determining, by the processor, the risk assessment by comparing the user device characteristic to historical transaction fraud data.

16. The system of claim 11, further comprising approving, by the processor, the payment request in response to transmitting the debit pull and the credit push.

17. An article of manufacture including a non-transitory, tangible computer readable storage medium having instructions stored thereon that, in response to execution by a computer-based system, cause the computer-based system to perform operations comprising:
executing, by the computer-based system, a payment risk analysis on a payment request, wherein the payment request comprises sender data, receiver data, and a payment amount, and wherein the payment risk analysis determines a risk assessment associated with the payment request;
generating, by the computer-based system, a payment processing request in response to the risk assessment comprising a low risk;
transmitting, by the computer-based system and based on the payment processing request, a debit pull to a sender bank from the sender data, wherein in response to receiving the debit pull the sender bank debits the payment amount from a sender account from the sender data; and
transmitting, by the computer-based system and based on the payment processing request, a credit push to a receiver bank from the receiver data, wherein in response to receiving the credit push the receiver bank credits the payment amount to a receiver account from the receiver data.

18. The article of manufacture of claim 17, wherein the debit pull is transmitted at a first time and the credit push is transmitted at a second time, and wherein the first time is the same or proximate the second time.

19. The article of manufacture of claim 18, further comprising approving, by the computer-based system, the payment request in response to transmitting the debit pull and the credit push, wherein in response to the payment request being approved the credited payment amount is available for use by a receiver associated with the receiver account.

20. The article of manufacture of claim 17, wherein the executing the payment risk analysis comprises:
validating, by the computer-based system, sender bank data from the sender data, wherein the sender bank data is validated by verifying sender bank login information from the sender bank data and validating that the sender account comprises sufficient funds to complete the payment request based on the payment amount;
capturing, by the computer-based system, a user device characteristic from a user device; and
comparing, by the computer-based system, the user device characteristic to historical transaction fraud data; and
determining, by the computer-based system, the risk assessment based on at least one of the validated sender bank data or the user device characteristic.
